(19) United States
(12) Patent Application Publication
(10) Pub. No.: US 2006/0111180 A1
(43) Pub. Date: May 25, 2006

(54) TOUCH-CONTROL GAME CONTROLLER

(75) Inventor: Chiu-Hao Cheng, TAIPEI (TW)

Correspondence Address: ZEROPLUS TECHNOLOGY CO., LTD., 3F, NO. 121, CHIEN-PA ROAD, CHUNGHO CITY, TAIPEI HSIEN, TW

(73) Assignee: ZEROPLUS TECHNOLOGY CO., LTD., Miaoli Hsien, (TW)

(21) Appl. No.: 10/904,755

(22) Filed: Nov. 25, 2004

(51) Int. Cl. A63F 13/00

(52) U.S. Cl. 463/36; 463/37

(57) ABSTRACT

Disclosed is a touch-control game controller, which includes a housing, a control circuit mounted inside the housing, a plurality of operating buttons mounted on the surface of the housing and respectively connected to the control circuit for operation by the user to provide a respective control signal to the control circuit, a communication interface connectable to a game machine main unit and controllable by the control circuit to transmit each produced control signal to the connected game machine main unit; and a touch-control panel provided at the surface of the housing and electrically connected to the control circuit for touching by the user to provide a corresponding control signal to the control circuit for further transmission by the control circuit through the communication interface to the game machine main unit.

### BACKGROUND OF THE INVENTION

1. Field of the Invention

The present invention relates generally to a game controller for controlling the operation of a game machine main unit and more particularly, to a touch-control game controller, which has a touch-control panel for producing a corresponding control signal to the game machine main unit upon touching of a touch pen or the user's finger.

2. Description of the Related Art

Every video game provider keeps trying hard to create new game software to attract consumers to play. In consequence, various flying, racing, and sports video games have been created after shooting and fighting video games. Furthermore, in order to increase the difficulty and bring more fun to the players, the control of video game has been complicated and the control precision has become more critical than ever. In an early design video game machine, a crossed button (joystick) is used to control the cursor. However, this design of game machine control button (joystick) does not provide a high precision. An user using this design of game machine control button (joystick) cannot enjoy the reality from the game. Therefore, different new game controllers are developed. FIG. 9 shows game controller for use with a game machine to run a flying game. According to this design, the game controller comprises a housing A and a control unit B installed in the housing A. The control unit B comprises a directional button B1, a plurality of operating buttons B2, and joysticks B3. The user can operate the directional button B1 and the operating buttons B2 to control a cursor-control video game. The user can also use the joysticks B3 to simulate a 3D game, for example, flying game. This design of game controller is still not satisfactory in function because the joysticks B3 tend to be damaged by an external body accidentally. If the user employs much force to the joysticks B3 when playing the game, the joysticks B3 may be damaged easily. Further, this design of game controller cannot be used to control a video game that requires a rotary motion (for example, racing game). FIG. 10 shows a rotary motion controllable game controller according to the prior art. According to this design, the game controller has a rotator B4 mounted on the outside wall of the housing A. The user can rotate the rotator B4 to control the rotation of the steering wheel of a racing car in a video racing game. This game controller is suitable for controlling video games that require a steering wheel control. However, because the rotator B4 is a mechanical device, it tends to be damaged if the user pushes the rotator B4 suddenly with a great force or rotates the rotator B4 over the set range.

### SUMMARY OF THE INVENTION

The present invention has been accomplished under the circumstances in view. It is the main object of the present invention to provide a touch-control game controller, which enables the user to control the operation of the game machine main unit through an on-screen touch control. It is another object of the present invention to provide a touch-control game controller, which is practical for use with the game machine main unit to run any of a variety of video games. To achieve these and other objects of the present invention, the touch-control game controller comprises a housing, a control circuit mounted inside the housing, a plurality of operating buttons mounted on the surface of the housing and respectively connected to the control circuit for operation by the user to provide a respective control signal to the control circuit, a communication interface connectable to a game machine main unit and controllable by the control circuit to transmit each produced control signal to the connected game machine main unit; and at least one touch-control panel respectively provided at the surface of the housing and electrically connected to the control circuit for touching by the user to provide a corresponding control signal to the control circuit for further transmission by the control circuit through the communication interface to the game machine main unit. In an alternate form of the present invention, a wireless transmitter and receiver circuit is used to substitute for the communication interface for communication with the game machine main unit wirelessly.

### BRIEF DESCRIPTION OF THE DRAWING

FIG. 1 is a schematic drawing showing the outer appearance of a touch-control game controller according to a first embodiment of the present invention.

FIG. 2 is a circuit block diagram of the touch-control game controller according to the first embodiment of the present invention.

FIG. 3 is a schematic drawing showing one operation status of the touch-control game controller according to the first embodiment of the present invention.

FIG. 4 is a schematic drawing showing another operation status of the touch-control game controller according to the first embodiment of the present invention.

FIG. 5 is a circuit block diagram of a touch-control game controller according to a second embodiment of the present invention.

FIG. 6 is a schematic drawing showing the outer appearance of the touch-control game controller according to the second embodiment of the present invention.

FIG. 7 is a circuit block diagram of a touch-control game controller according to a third embodiment of the present invention.

FIG. 8 is a schematic drawing showing the outer appearance of the touch-control game controller according to a fourth embodiment of the present invention.

FIG. 9 is a schematic drawing showing the outer appearance of a flying game simulation game controller according to the prior art.

FIG. 10 is a schematic drawing showing the outer appearance of a rotary motion controllable game controller according to the prior art.

### DETAILED DESCRIPTION OF PREFERRED EMBODIMENTS

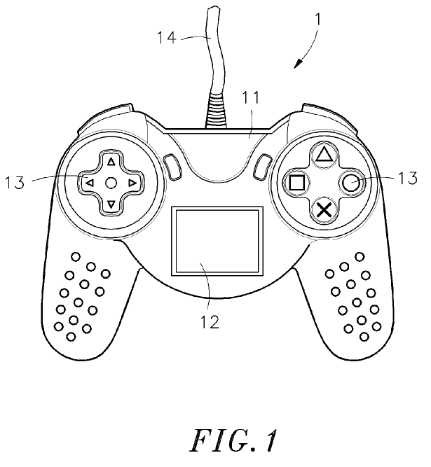

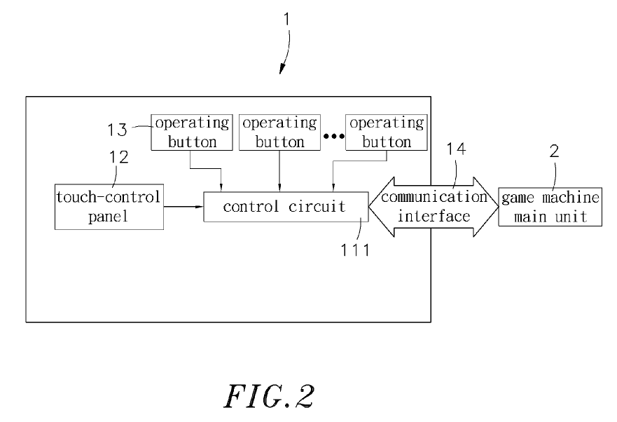

Referring to FIGS. 1 and 2, a touch-control game controller 1 is shown comprising a housing 11, a control circuit 111 mounted inside the housing 11, a touch-control panel 12 and two sets of operating buttons (directional buttons) 13 mounted on the surface of the housing 111 and respectively electrically connected to the control circuit 111, and a communication interface 14 extended from the control circuit 111 to the outside of the housing 111 and connectable to a game machine main unit 2. When the user uses the touch-control panel 12 and the operating buttons 13 to play a game, the control circuit 111 receives signal from the touch-control panel 12 and the operating buttons 13 and transmit received signal to the game machine main unit 2 through the communication interface 14, causing the game machine main unit 2 to make a respective game control.

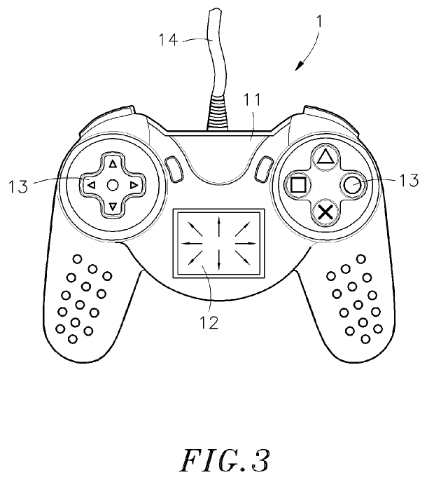

Referring to FIG. 3 and FIG. 2 again, when the user moves the finger or touch pen over the surface of the touch-control panel 12 (see the arrow head sign I FIG. 3), the touch-control panel 12 will send the coordinates of the movement to the control circuit 111, enabling the control circuit 111 to send this coordinates signal through the communication interface 14 to the game machine main unit 2 so that the game machine main unit 2 can control the displacement of the cursor of the game subject to this coordinates signal.

Further, the touch-control panel 12 can be a resistive touch panel or capacitive touch panel, having an impact-resisting pressure-resisting tough plastic surface for durable use. Therefore, pressing the touch-control panel 12 with excessive pressure from the fingers during playing of a game does not cause damage to the touch-control panel 12. The touch-control panel 12 is directly installed in the surface of the housing 11, it does not increase the dimensions of the touch-control game controller 1.

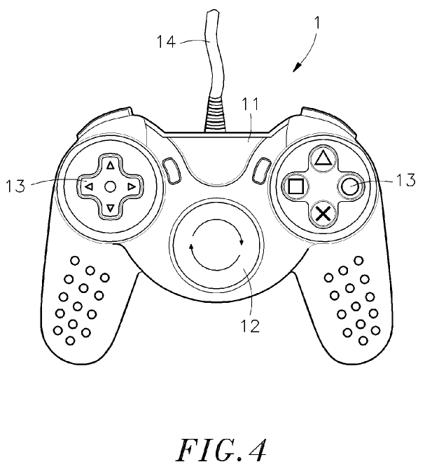

Referring to FIG. 4 and FIG. 2 again, the user can move the finger or touch pen over the surface of the touch-control panel 12 through a circular motion (see the arrowhead sign in FIG. 4) to simulate the control of the steering wheel of a race car, and this circular motion control signal will be sent to the game machine main unit 2 by the control circuit 111 through the communication interface 14.

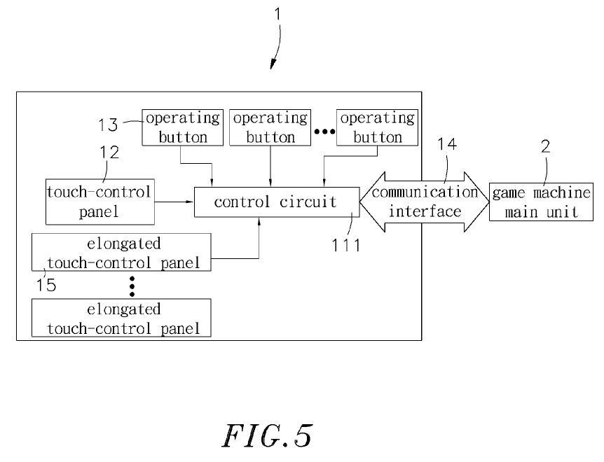

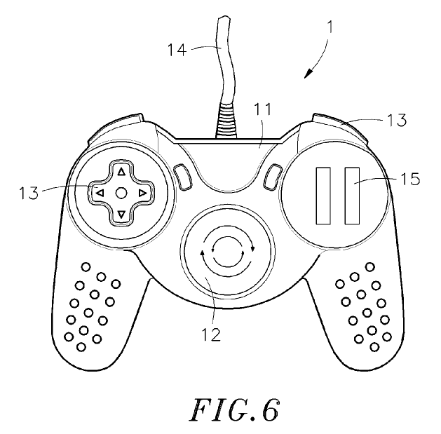

FIGS. 5 and 6 show a touch-control game controller according to the second embodiment of the present invention. This embodiment is substantially similar to the aforesaid first embodiment with the exception of the added elongated touch-control panels 15. The user can move the finger or a touch pen over the surface of each elongated touch-control panel 15 to produce a respective displacement signal, enabling the produced displacement signal to be sent by the control circuit 111 through the communication interface 14 to the game machine main unit 2 to make a corresponding game control, for example, accelerating or braking of a race car.

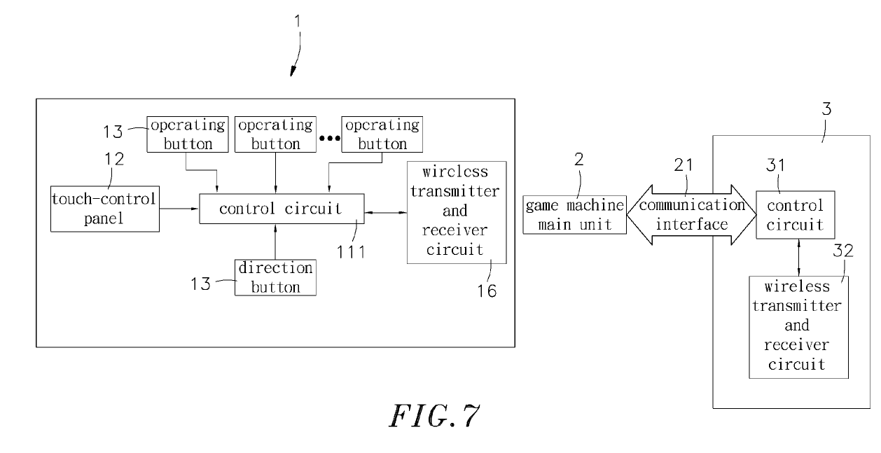

FIG. 7 is a circuit block diagram of a touch-control game controller according to the third embodiment of the present invention. This embodiment is substantially similar to the aforesaid first embodiment with the exception of the use of a wireless transmitter and receiver circuit 16 to substitute for the aforesaid communication interface 14. Further, the game machine game unit 2 has a wireless transceiver 3 connected thereto. The wireless transceiver 3 comprises a control circuit 31 and a wireless transmitter and receiver circuit 32 connected to the control circuit 31. The control circuit 31 of the wireless transceiver 3 is connected to a communication interface 21 of the game machine main unit 2. During operation, the control circuit 111 sends every control signal produced by the operating buttons 13 or the touch-control panel 12 to the wireless transmitter and receiver circuit 32 of the wireless transceiver 3 through the wireless transmitter and receiver circuit 16 wirelessly, and then the control circuit 31 of the wireless transceiver 3 sends every received control signal to the game machine main unit 2 through the communication interface 21 to control the execution of the game. This wireless design prevents interruption of communication between the touch-control game controller 1 and the game machine main unit 2. This interruption problem occurs frequently in the aforesaid first embodiment when the user moves the game controller 1 to stretch the communication interface 14 violently during the game.

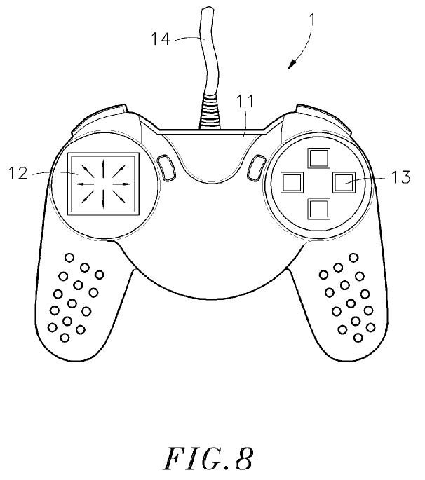

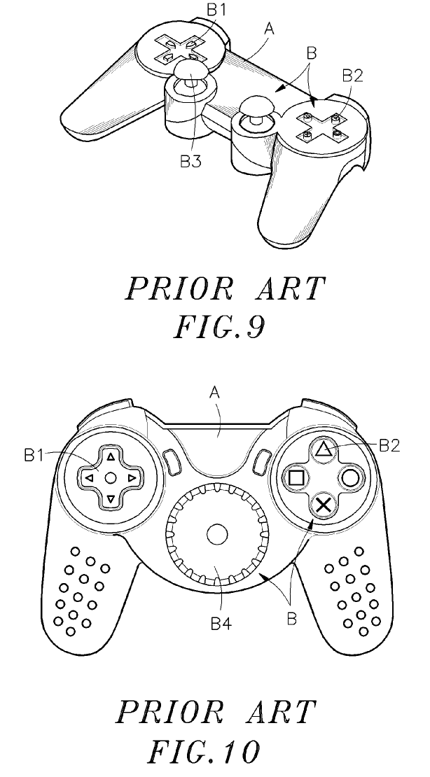

FIG. 8 shows a touch-control game controller according to the fourth embodiment of the present invention. According to this embodiment, a touch-control panel 12 is used to substitute for one set of operating buttons (directional buttons) 13 of the aforesaid first embodiment.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A touch-control game controller for use with a game machine main unit to run a game software, the touch-control game controller comprising a housing, a control circuit mounted inside said housing, a plurality of operating buttons mounted on the surface of said housing and respectively connected to said control circuit for operation by the user to provide a respective control signal to said control circuit, and a communication interface connectable to a game machine main unit and controllable by said control circuit to transmit each produced control signal to the connected game machine main unit;
wherein at least one touch-control panel is provided at the surface of said housing and electrically connected to said control circuit for touching by the user to provide a corresponding control signal to said control circuit for further transmission by said control circuit through said communication interface to the game machine main unit being connected to said communication interface.

2. The touch-control game controller as claimed in claim 1, wherein each said touch-control panel is adapted to produce a signal indicative of the direction and amount of movement of an external object being kept in contact with the respective touch-control panel.

3. The touch-control game controller as claimed in claim 1, wherein each said touch-control panel is capable of producing a signal indicative of the direction and amount of a circular movement of an external object being kept in contact with the respective touch-control panel.

4. The touch-control game controller as claimed in claim 1, wherein each said touch-control panel is a resistive touch panel.

5. The touch-control game controller as claimed in claim 1, wherein each said touch-control panel is a capacitive touch panel.

6. The touch-control game controller as claimed in claim 1, wherein said operating buttons are on-screen buttons of at least one resistive touch-control panel.

7. The touch-control game controller as claimed in claim, wherein said operating buttons are on-screen buttons of at least one capacitive touch-control panel.

8. The touch-control game controller as claimed in claim 1, wherein said at least one touch-control panel includes at least one elongated touch-control panel.

9. A touch-control game controller for use with a game machine main unit to run a game software, the touch-control game controller comprising a housing, a control circuit mounted inside said housing, a plurality of operating buttons mounted on the surface of said housing and respectively connected to said control circuit for operation by the user to provide a respective control signal to said control circuit, and a wireless transmitter and receiver circuit electrically connected to said control circuit and controllable by said control circuit to transmit each produced control signal to an external game machine main unit wirelessly;
wherein at least one touch-control panel is provided at the surface of said housing and electrically connected to said control circuit for touching by the user to provide a corresponding control signal to said control circuit for further transmission by said control circuit through said wireless transmitter and receiver circuit to an external game machine main unit wirelessly.

10. The touch-control game controller as claimed in claim 9, wherein each said touch-control panel is adapted to produce a signal indicative of the direction and amount of movement of an external object being kept in contact with the respective touch-control panel.

11. The touch-control game controller as claimed in claim 9, wherein each said touch-control panel is capable of producing a signal indicative of the direction and amount of a circular movement of an external object being kept in contact with the respective touch-control panel.

12. The touch-control game controller as claimed in claim 9, wherein each said touch-control panel is a resistive touch panel.

13. The touch-control game controller as claimed in claim 9, wherein each said touch-control panel is a capacitive touch panel.

14. The touch-control game controller as claimed in claim 9, wherein said operating buttons are on-screen buttons of at least one resistive touch-control panel.

15. The touch-control game controller as claimed in claim, wherein said operating buttons are on-screen buttons of at least one capacitive touch-control panel.

16. The touch-control game controller as claimed in claim 9, wherein said at least one touch-control panel includes at least one elongated touch-control panel.
